(19) United States
(12) Patent Application Publication
(10) Pub. No.: US 2026/0219803 A1
(43) Pub. Date: Jul. 30, 2026

(54) STORAGE CONTROLLER EXECUTING DEFENSE CODE, METHOD OF OPERATING THE SAME, AND STORAGE DEVICE HAVING THE SAME

(71) Applicant: SAMSUNG ELECTRONICS CO., LTD., Suwon-si (KR)

(72) Inventors: Changwan HA, Suwon-si (KR); Byung-Jo KIM, Suwon-si (KR); Young-Sub OH, Suwon-si (KR); Kyungduk LEE, Suwon-si (KR)

(73) Assignee: SAMSUNG ELECTRONICS CO., LTD., Suwon-si (KR)

(21) Appl. No.: 19/451,532

(22) Filed: Jan. 16, 2026

(30) Foreign Application Priority Data
Jan. 24, 2025 (KR) 10-2025-0011580

(51) Int. Cl. G06F 3/06

(52) U.S. Cl. CPC G06F 3/0655; G06F 3/0604; G06F 3/064; G06F 3/0679

(57) ABSTRACT

Disclosed is an operating method of a storage controller configured to communicate with a non-volatile memory device. The operating method includes reading first block status information of a first memory block of the non-volatile memory device, where the first block status information includes a first erase timestamp and a first power count value of the first memory block; reading a current power count value associated with the storage controller; generating a current timestamp associated with the storage controller based on the first power count value coinciding with the current power count value; and performing a read operation of the first memory block in accordance with a defense code based on an erase time period between the current timestamp and the first erase timestamp exceeding a threshold time period.

### CROSS-REFERENCE TO RELATED APPLICATIONS

This application is based on and claims priority under 35 U.S.C. § 119 to Korean Patent Application No. 10-2025-0011580 filed on January 24, 2025, in the Korean Intellectual Property Office, the disclosures of which are incorporated by reference herein in their entireties.

### BACKGROUND

Embodiments of the present disclosure described herein relate to a storage controller, and more particularly, relate to a storage controller executing a defense code, an operating method thereof, and a storage device including the same.

A memory device stores data in response to a write request and outputs data stored therein in response to a read request. A memory device is classified as a volatile memory device when it loses data stored therein when a power is turned off, such as a dynamic random access memory (DRAM) device or a static RAM (SRAM) device. A memory device is classified as a non-volatile memory device when it data stored therein even when a power is turned off, such as a flash memory device, a phase-change RAM (PRAM), a magnetic RAM (MRAM), or a resistive RAM (RRAM).

Non-volatile memory devices may be also referred to as a “storage device” storing a large amount of data. The storage device may execute a defense code to maintain the reliability of data stored therein. For example, the storage device may detect an error of the stored data based on the defense code and may perform an error correction operation.

### SUMMARY

Embodiments of the present disclosure provide a storage controller executing a defense code, an operating method thereof, and a storage device including the same.

According to an embodiment, an operating method of a storage controller configured to communicate with a non-volatile memory device is provided. The operating method includes reading first block status information of a first memory block of the non-volatile memory device, where the first block status information includes a first erase timestamp and a first power count value of the first memory block; reading a current power count value associated with the storage controller; generating a current timestamp associated with the storage controller based on the first power count value coinciding with the current power count value; and performing a read operation of the first memory block in accordance with a defense code based on an erase time period between the current timestamp and the first erase timestamp exceeding a threshold time period.

According to an embodiment, a storage controller configured to communicate with a non-volatile memory device is provided. The storage controller includes a block manager configured to generate timestamps; a block status table configured to store first block status information of a first memory block of the non-volatile memory device; and a power manager configured to register a current power count value. The block manager is configured to read the first block status information; read the current power count value; generate a current timestamp based on the current power count value coinciding with a first power count value of the first block status information; and perform a read operation of the first memory block in accordance with a defense code based on an erase time period between the current timestamp and a first erase timestamp exceeding a threshold time period.

According to an embodiment, a storage device configured to communicate with a non-volatile memory device is provided. The non-volatile memory device that includes a first memory block, and a storage controller that communicates with the non-volatile memory device. The storage controller includes a block manager configured to generate timestamps; a block status table configured to store first block status information of a first memory block of the non-volatile memory device; and a power manager configured to register a current power count value. The block manager is configured to read the first block status information; read the current power count value; generate a current timestamp based on the current power count value coinciding with a first power count value of the first block status information; and perform a read operation of the first memory block in accordance with a defense code based on an erase time period between the current timestamp and a first erase timestamp exceeding a threshold time period.

### BRIEF DESCRIPTION OF DRAWINGS

The above and other objects and features of the present disclosure will become apparent by describing in detail embodiments thereof with reference to the accompanying drawings.

FIG. 1 is a block diagram of an electronic device according to an embodiment of the present disclosure.

FIG. 2 is a diagram illustrating a storage controller according to an embodiment of the present disclosure.

FIG. 3 is a block diagram illustrating a non-volatile memory device according to an embodiment of the present disclosure.

FIG. 4 is a diagram describing data stored in a storage device according to an embodiment of the present disclosure.

FIG. 5 is a diagram illustrating an erase operation of a storage device according to an embodiment of the present disclosure.

FIG. 6 is a diagram illustrating a block status table according to an embodiment of the present disclosure.

FIG. 7 is a diagram illustrating an operation method of a storage device according to an embodiment of the present disclosure.

FIG. 8 is a diagram illustrating an operation method of a storage device according to an embodiment of the present disclosure.

FIG. 9 is a diagram illustrating an operating method of a storage device according to an embodiment of the present disclosure.

FIG. 10 is a flowchart illustrating an operating method of a storage controller, according to an embodiment of the present disclosure.

### DETAILED DESCRIPTION

Below, embodiments of the present disclosure will be described in detail and clearly to such an extent that one skilled in the art carries out embodiments of the present disclosure easily.

Function blocks corresponding to the terms “unit”, “module”, etc. used herein or illustrated in drawings may be implemented in the form of a software component, a hardware component, or a combination thereof. In embodiments, the software may be a machine code, firmware, an embedded code, and/or application software. In embodiments, the hardware may include an electrical circuit, an electronic circuit (e.g., an analog circuit or a digital circuit), a processor, a computer, an integrated circuit, integrated circuit cores, a pressure sensor, an inertial sensor, a microelectromechanical system (MEMS), a passive element, and/or a combination thereof. Below, to describe the technical idea of the present disclosure clearly, the description associated with the same components will be omitted.

As used herein, each of the phrases such as “A or B”, “at least one of A and B”, “at least one of A or B”, “at least one of A, B, or C”, “at least one of A, B, and C”, “at least one of A, B, or C”, and “at least one of B or C”, including the claims, may include any one of items listed together with the corresponding phrase among the phases, or all possible combinations thereof.

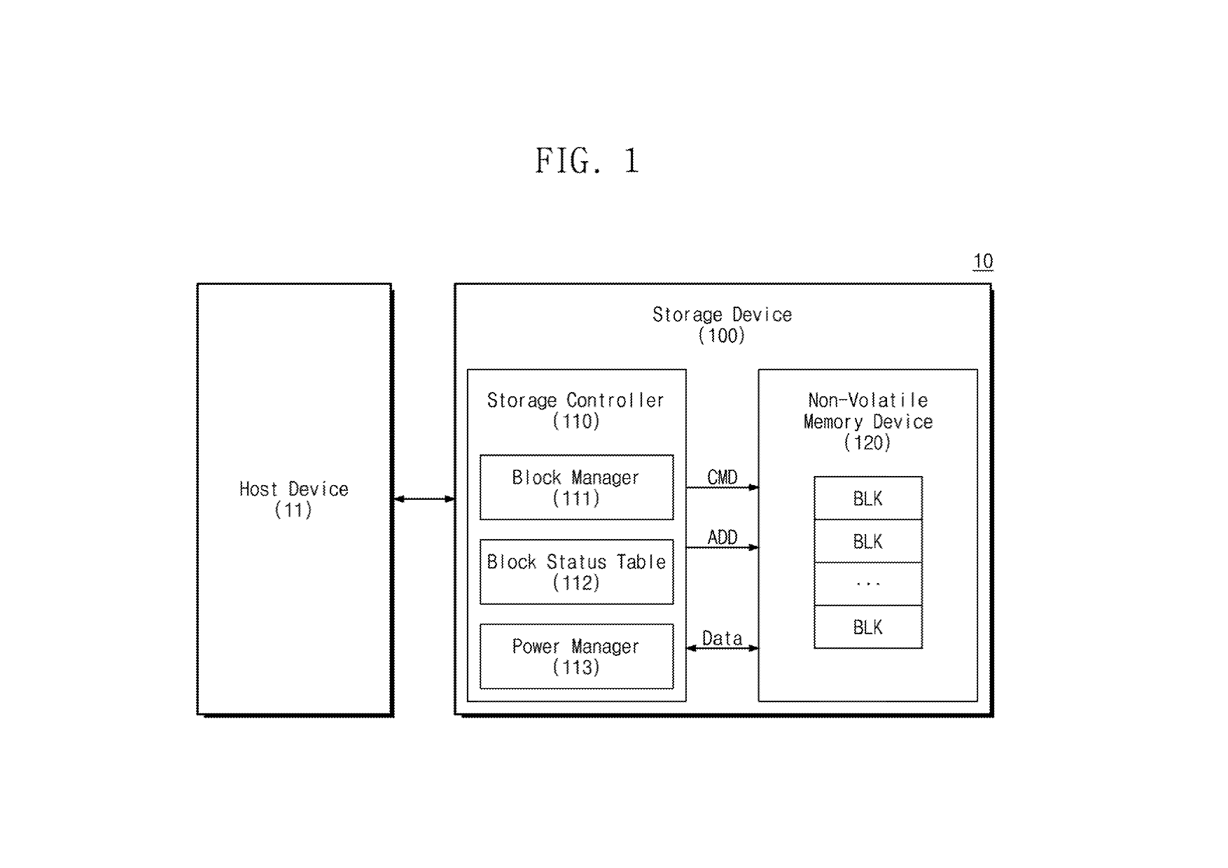

FIG. 1 is a block diagram of an electronic device according to an embodiment of the present disclosure. Referring to FIG. 1, an electronic device 10 may include a host device 11 and a storage device 100. The electronic device 10 may refer to a device, which is configured to manage a large amount of user data, such as a storage system, a server system, or a database server. The user data may include a variety of information to be provided to or by the user, such as an image, a video, a text, and a voice. Also, the electronic device 10 may be implemented with a computing system, which is configured to process a variety of information, such as a personal computer (PC), a notebook, a laptop, a server, a workstation, a tablet PC, a smartphone, a digital camera, and a black box. Embodiments listed herein should not be considered as limiting embodiments.

The host device 11 may control all operations of the storage device 100. For example, the host device 11 may store the user data in the storage device 100, may read the user data stored in the storage device 100, or may erase the user data stored in the storage device 100.

For example, the host device 11 may include a host processor and a host memory. The host processor may be implemented with a processing device such as a central processing unit (CPU), a graphic processing unit (GPU), or a neural processing unit (NPU).

The storage device 100 may include a storage controller 110 and a non-volatile memory device 120. While the diagrams in the present disclosure disclose only one non-volatile memory device 120, it will be understood that the present disclosure is not limited thereto. The storage controller 110 may perform a device management operation or a memory operation in the non-volatile memory device 120 based on a request of the host device 11, an internal operating policy, an operation algorithm of an internal firmware module. The memory operation may refer to an operation associated with processing of data, such as a write operation, a read operation, or an erase operation. The device management operation may refer to an operation for managing the non-volatile memory device 120, such as an initialization operation, a reset operation, a status check operation, or a defense code execution operation.

The storage controller 110 may provide a command CMD and an address ADD to the non-volatile memory device 120. The command CMD may indicate an operation to be performed in the non-volatile memory device 120. The address ADD may indicate a location where the operation corresponding to the command CMD is to be performed. The storage controller 110 may communicate data with the non-volatile memory device 120. The data may include data to be written through the write operation, data read through the read operation, a response indicating a processing result of the command CMD, etc.

The non-volatile memory device 120 may store data. The non-volatile memory device 120 may operate under control of the storage controller 110. The non-volatile memory device 120 may include a plurality of memory blocks BLK. The memory block BLK may be a unit of the erase operation. The non-volatile memory device 120 may erase the memory block BLK in response to the command CMD indicating the erase operation.

In embodiments, the non-volatile memory device 120 may be a flash memory device, but the scope of the present disclosure is not limited thereto. For example, the non-volatile memory device 120 may be one of various storage devices, which are capable of retaining data stored therein even when a power is turned off, such as a phase-change random access memory (PRAM), a magnetic random access memory (MRAM), a resistive random access memory (RRAM), and a ferroelectric random access memory (FRAM).

The storage controller 110 may include a block manager 111, a block status table 112, and a power manager 113. The block manager 111 may manage the erase operation of the storage device 100 and may manage the execution of a defense code for the storage device 100.

The block manager 111 may manage the erase operation of data stored in the non-volatile memory device 120. For example, the block manager 111 may provide the non-volatile memory device 120 with the command CMD indicating the erase operation and the address ADD indicating a location of the memory block BLK in which the erase operation will be performed.

The non-volatile memory device 120 may perform the erase operation of the memory block BLK based on a command and an address and may return, to the block manager 111, a done response indicating that the erase operation is performed or a failure response indicating that the erase operation is not performed.

The block manager 111 may generate or obtain block status information corresponding to a time point at which the erase operation is performed, based on the done response of the erase operation and may store the block status information in the block status table 112.

The block status information may include an erase timestamp and an erase power count value. The erase timestamp may correspond to a time point at which the erase timestamp of the memory block BLK is performed. The erase power count value may correspond to a power count value of the storage controller 110 at the time point at which the erase operation of the memory block BLK is performed.

The block manager 111 may execute a defense code for the non-volatile memory device 120. In other words, in an embodiment, , the block manager 111 may perform an operation for improving the reliability or integrity of data stored in the non-volatile memory device 120, based on the defense code. Below, examples of defense code execution according to embodiments of the present disclosure will be described.

In embodiments, the block manager 111 may perform an error correction operation based on the defense code. In other words, in an embodiment, , the block manager 111 may perform the read operation on data stored in the memory block BLK, may obtain original data corresponding to the read operation, and may perform the error correction operation of the original data. For example, the original data may include parity data, and the block manager 111 may identify an error of the original data based on the parity data.

In embodiments, the block manager 111 may obtain an error level value by using the error correction operation. When the error level value exceeds a threshold level value, the block manager 111 may perform a reclaim operation of the original data. The reclaim operation may refer to an operation of moving valid data of the original data to any other memory block before an uncorrectable error occurs in the original data.

In embodiments, the block manager 111 may perform a background read operation based on the defense code. The background read operation may indicate a series of processes of internally performing the read operation, detecting a data error, and correcting the data error, in a state where the storage device 100 does not receive a read request from the host device 11. Regardless of the direction of the host device 11, the read operation may be periodically performed in the storage device 100, and an error of data may be corrected in the storage device 100. This may make it possible to improve the reliability of the storage device 100.

In embodiments, the background read operation may include a patrol read operation. The patrol read operation may refer to an operation of selecting at least one representative page among pages of the memory block BLK and performing the background read operation on the representative page. The representative page may include data having high importance from among the data of the memory block BLK or may include data having a high error occurrence frequency from among the data of the memory block BLK.

The storage controller 110 may execute the defense code to detect an error of data stored in the non-volatile memory device 120 and to perform operations corresponding to the detected error. However, the execution of the defense code may cause the read disturb in association with the stored data.

In other words, the non-volatile memory device 120 stores data in a memory cell. When the read operation for reading the data stored in the memory cell is performed, a threshold voltage of a memory cell adjacent to the memory cell may change due to the leakage current. The above phenomenon may be referred to as “read disturb”. When the read disturb is accumulated, an error may occur in the data.

The power manager 113 may perform all operations associated with power management of the storage device 100. For example, the power manager 113 may supply a power necessary for the operation of the storage device 100 and may manage data associated with the power.

The power manager 113 may register the power count value of the storage device 100. The power count value may refer to the number of power events which occur in the storage device 100. In detail, the power manager 113 may determine whether the power event occurs in the storage device 100. The power manager 113 may increase the power count value as much as a unit value in response to determining that the power event occurs.

For example, the power event may include the event that the power is again supplied after the storage device 100 is powered off. The power manager 113 may detect the event (hereinafter referred to as a “power resupply event”) that the power is resupplied to the storage device 100. The power manager 113 may increase the power count value in response to detecting the power resupply event.

The power manager 113 may provide the registered power count value to the block manager 111 in response to a request of the block manager 111. For example, to obtain the power count value corresponding to a time point at which the erase operation of the memory block BLK is performed, the block manager 111 may request the power count value of the power manager 113. Below, the power count value corresponding to the time point at which the erase operation is performed may be referred to as an “erase power count value”.

The block manager 111 may selectively execute the defense code, based on the block status information. For example, the block manager 111 may determine whether to execute the defense code for the memory block BLK, based on the erase timestamp and a current timestamp of the memory block BLK in which the defense code will be executed.

The block manager 111 may determine whether to execute the defense code for the memory block BLK, based on the erase power count value of the memory block BLK and a current power count value.

The storage controller 110 according to embodiments of the present disclosure may determine whether to execute the defense code, based on the block status information. The storage controller 110 may select data with high reliability and may omit the execution of the defense code for the data with high reliability. As the execution of the defense code is omitted, a computational resource for executing the defense code may be saved, and the read disturb according to the read operation of the defense code may be suppressed.

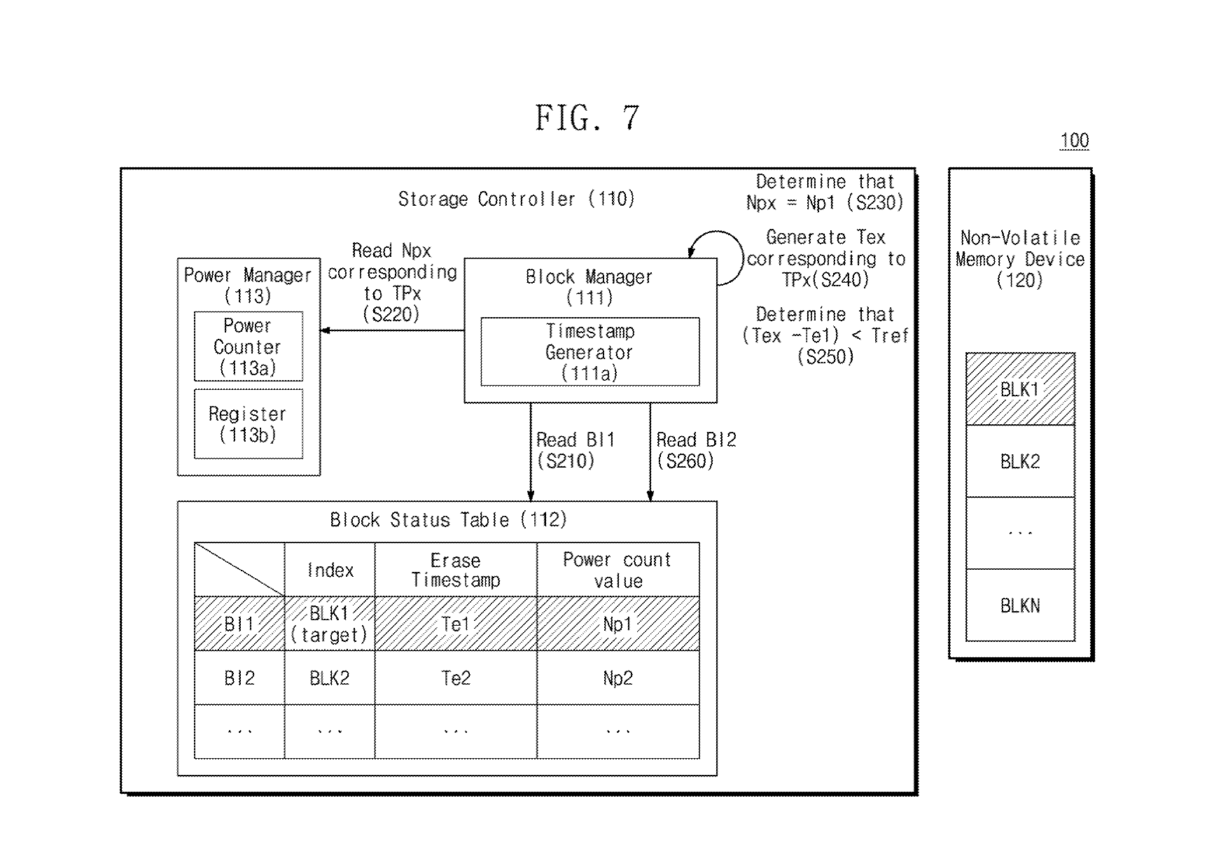

How the storage controller 110 according to embodiments of the present disclosure executes the defense code will be described in detail with reference to FIGS. 7 to 9.

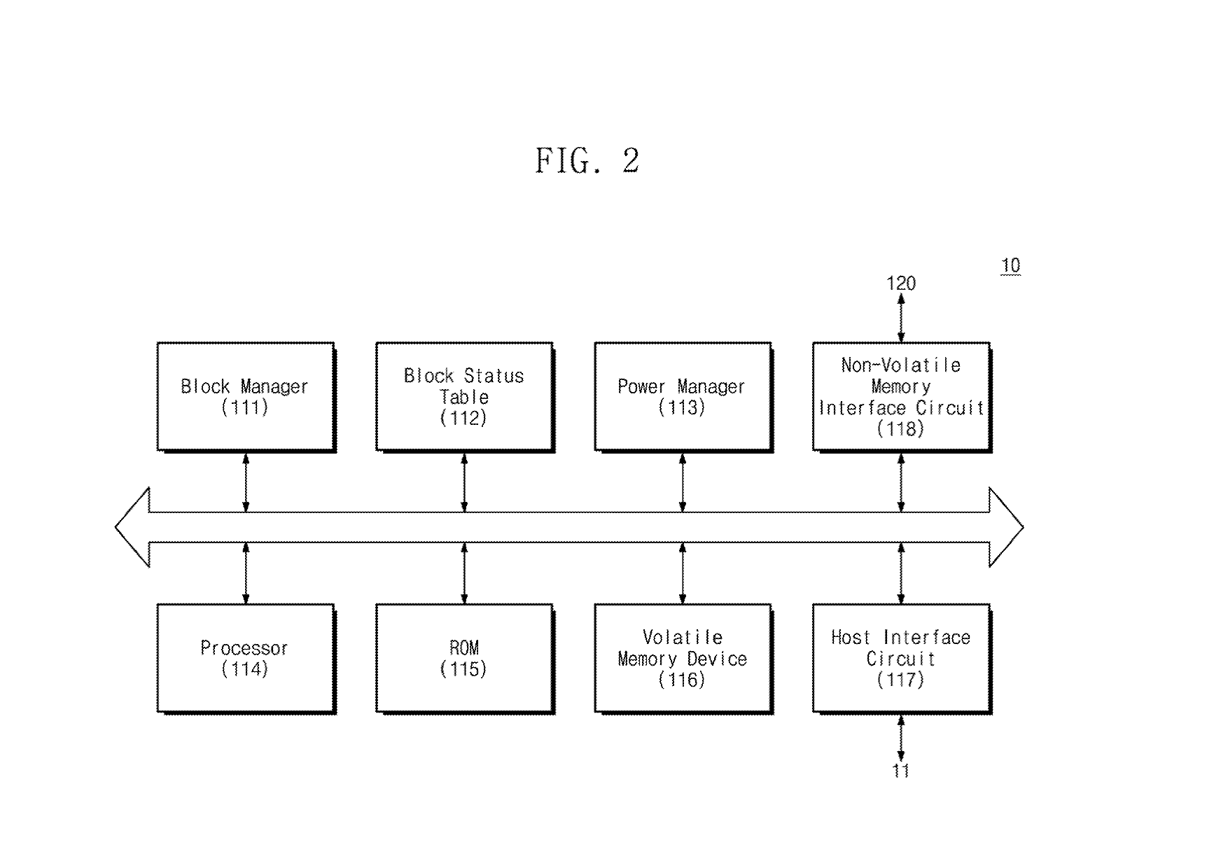

FIG. 2 is a diagram describing a storage controller according to embodiments of the present disclosure. Referring to FIGS. 1 and 2, the storage controller 110 may communicate with the host device 11 and the non-volatile memory device 120. The storage controller 110 may include the block manager 111, the block status table 112, the power manager 113, a processor 114 (may be more than one processor in an embodiment), a read only memory (ROM) 115, a volatile memory device 116, a host interface circuit 117, and a non-volatile memory interface circuit 118.

The block manager 111, the block status table 112, and the power manager 113 of FIG. 2 may correspond to the block manager 111, the block status table 112, and the power manager 113 of FIG. 1, and thus, additional description will be omitted to avoid redundancy.

The processor 114 may control all operations of the storage controller 110. The processor 114 may drive a firmware module by executing instructions loaded to the ROM 115 or the volatile memory device 116.

The ROM 115 may store information necessary for the operation of the storage controller 110. For example, the ROM 115 may store an instruction which is executed by the processor 114.

The volatile memory device 116 may be implemented with a dynamic random access memory (DRAM), a static DRAM (SRAM), etc. The volatile memory device 116 may store an instruction which is executed by the processor 114. The instruction stored in the volatile memory device 116 may be an instruction provided from the non-volatile memory device 120 or the host device 11.

At least some of the functions of the block manager 111, the block status table 112, and the power manager 113 may be implemented with a software module. For example, the processor 114 may implement at least some of the functions of the block manager 111, the block status table 112, and the power manager 113 by loading the instructions stored in the non-volatile memory device 120 to the volatile memory device 116 and executing the loaded instructions. As another example, the block status information of the block status table 112 may be stored in the volatile memory device 116 and the non-volatile memory device 120.

The storage controller 110 may communicate with external devices through the host interface circuit 117 and the non-volatile memory interface circuit 118.

The host interface circuit 117 may communicate with the host device 11 and the storage controller 110. In embodiments, the host interface circuit 117 may be implemented based on at least one of various interfaces such as a serial ATA (SATA) interface, a peripheral component interconnect express (PCIe) interface, a serial attached SCSI (SAS), a non-volatile memory (NVMe) interface, and a universal flash storage (UFS) interface.

The non-volatile memory interface circuit 118 may communicate with the storage controller 110 and the non-volatile memory device 120. In embodiments, the non-volatile memory interface circuit 118 may be implemented based on the NAND interface.

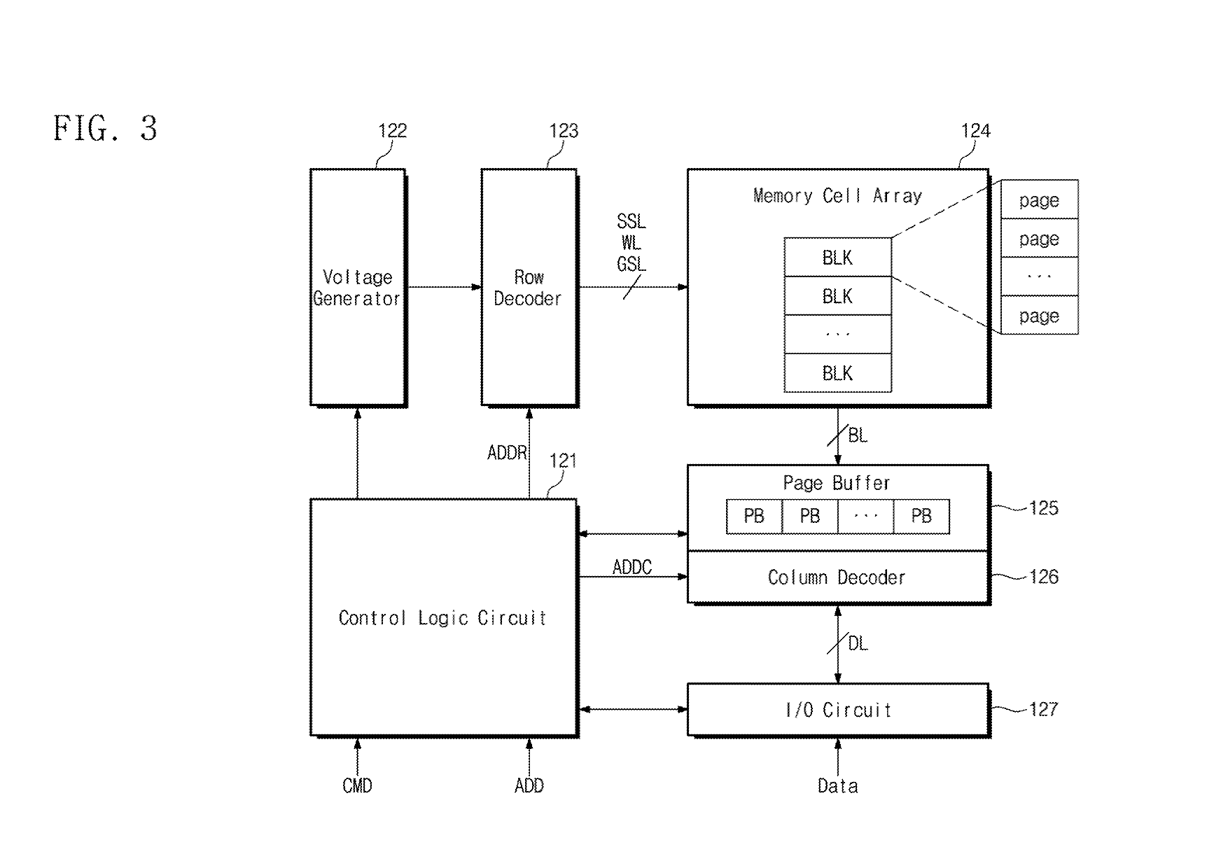

FIG. 3 is a block diagram describing a non-volatile memory device (e.g., non-volatile memory device 116) according to embodiments of the present disclosure. Referring to FIGS. 1 and 3, the non-volatile memory device 120 may include a control logic circuit 121, a voltage generator 122, a row decoder 123, a memory cell array 124, a page buffer 125, a column decoder 126, and an input/output (I/O) circuit 127.

The control logic circuit 121 may receive the command CMD and the address ADD from the storage controller 110. The command CMD may refer to a signal indicating an operation to be performed by the non-volatile memory device 120, such as a read operation, a write operation, or an erase operation. The address ADD may include a row address ADDR and a column address ADDC. The control logic circuit 121 may generate the row address ADDR and the column address ADDC based on the address ADD.

Under control of the control logic circuit 121, the voltage generator 122 may control voltages to be applied to the memory cell array 124 through the row decoder 123.

The row decoder 123 may receive the row address ADDR from the control logic circuit 121. The row decoder 123 may be connected to the memory cell array 124 through string selection lines SSL, word lines WL, and ground selection lines GSL. The row decoder 123 may decode the row address ADDR and may control voltages to be applied to the string selection lines SSL, the word lines WL, and the ground selection lines GSL based on a decoding result and voltages received from the voltage generator 122.

The memory cell array 124 may store data. The memory cell array 124 may include the plurality of memory blocks BLK. Each of the plurality of memory blocks BLK may include a plurality of pages. The memory block BLK may be a unit by which the erase operation of data is performed. The page may be a unit by which the read operation or the write operation of data is performed.

The page buffer 125 may include a plurality of page buffers PB. The page buffer 125 may be connected to the memory cell array 124 through bit lines BL. The page buffer 125 may read data from the memory cell array 124 by sensing voltages of the bit lines BL.

The column decoder 126 may receive the column address ADDC from the control logic circuit 121. The column decoder 126 may decode the column address ADDC and may provide the data read by the page buffer 125 to the I/O circuit 127 based on a decoding result.

The column decoder 126 may receive data from the I/O circuit 127 through data lines DL. The column decoder 126 may receive the column address ADDC from the control logic circuit 121. The column decoder 126 may decode the column address ADDC and may provide the data received from the I/O circuit 127 to the page buffer 125 based on a decoding result. The control logic circuit 121 may store data in the memory cell array 124 by controlling the voltage generator 122 and the row decoder 123 by referring to data stored in the page buffer 125.

The I/O circuit 127 may be connected to the column decoder 126 through the data lines DL. The I/O circuit 127 may receive data from the storage controller 110 and may transfer the received data to the column decoder 126 through the data lines DL. The I/O circuit 127 may receive data from the column decoder 126 through the data lines DL and may provide the received data to the storage controller 110.

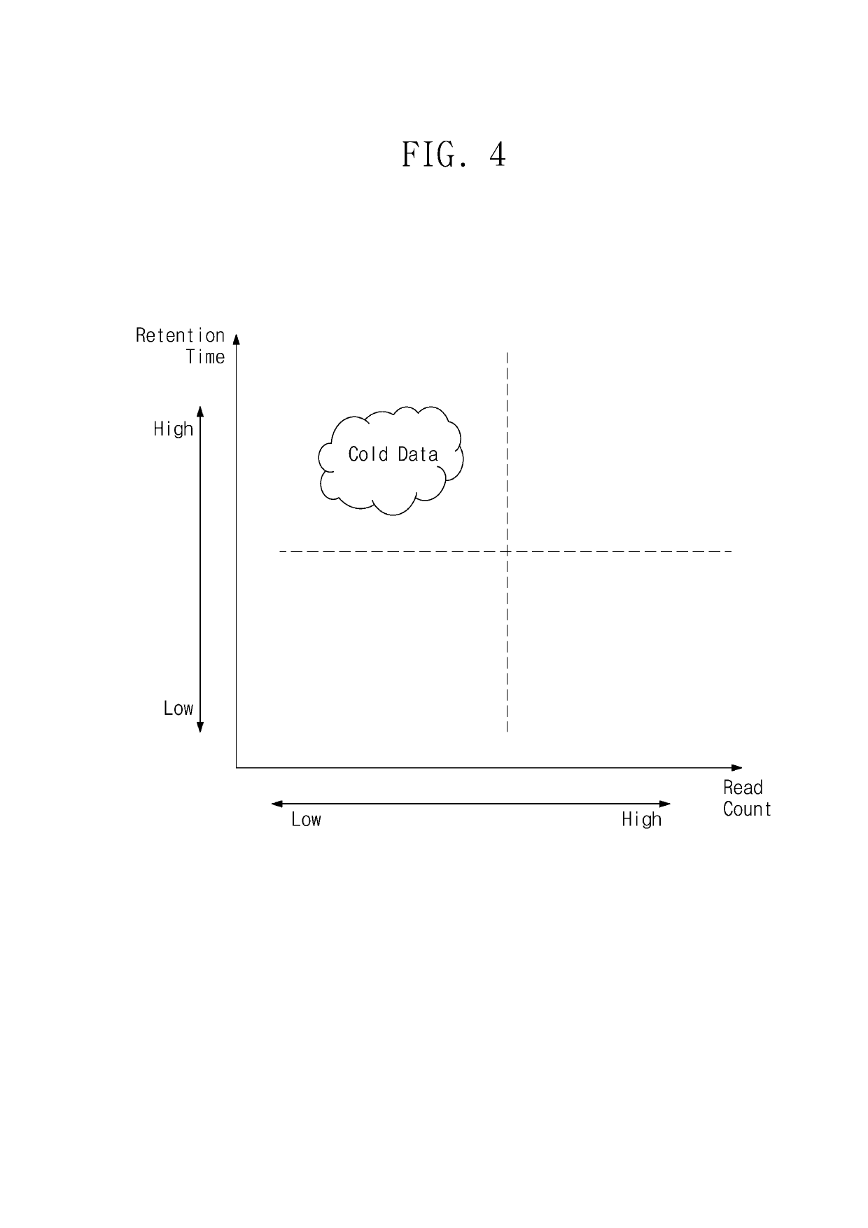

FIG. 4 is a diagram describing data stored in a storage device according to embodiments of the present disclosure. Referring to FIGS. 1, 3, and 4, data stored in the storage device 100 may be classified depending on a retention time and a read count value. In FIG. 4, the horizontal axis represents a read count value, and the vertical axis represents a retention time.

The retention time may refer to a duration during which data stored in the storage device 100 are retained. As the retention time increases, the degradation of retention may occur in the storage device 100. The degradation of retention may indicate a phenomenon in which threshold voltages of memory cells of the memory cell array 124 change over time due to the leakage of charges trapped in charge trap layers of the memory cells after charges are trapped in the charge trap layers of the memory cells such that data are stored in the memory cells.

The read count value may indicate the number of times that the read operation on data is performed. When the read operation is performed, the storage device 100 may execute the defense code together with one or more other codes. For example, when the storage device 100 performs the read operation, the storage device 100 may perform the error correction operation together based on the defense code.

Data having a long retention time and a small read count value may be referred to as “cold data”. The cold data has the high probability that the degradation of retention is caused due to a long retention time and has the high probability that the defense code is not executed. Accordingly, the reliability of the cold data may be low.

Therefore, there is a requirement for an operating method of the storage device 100 that determines whether the data stored in the storage device 100 is the cold data and selectively executes the defense code for the cold data.

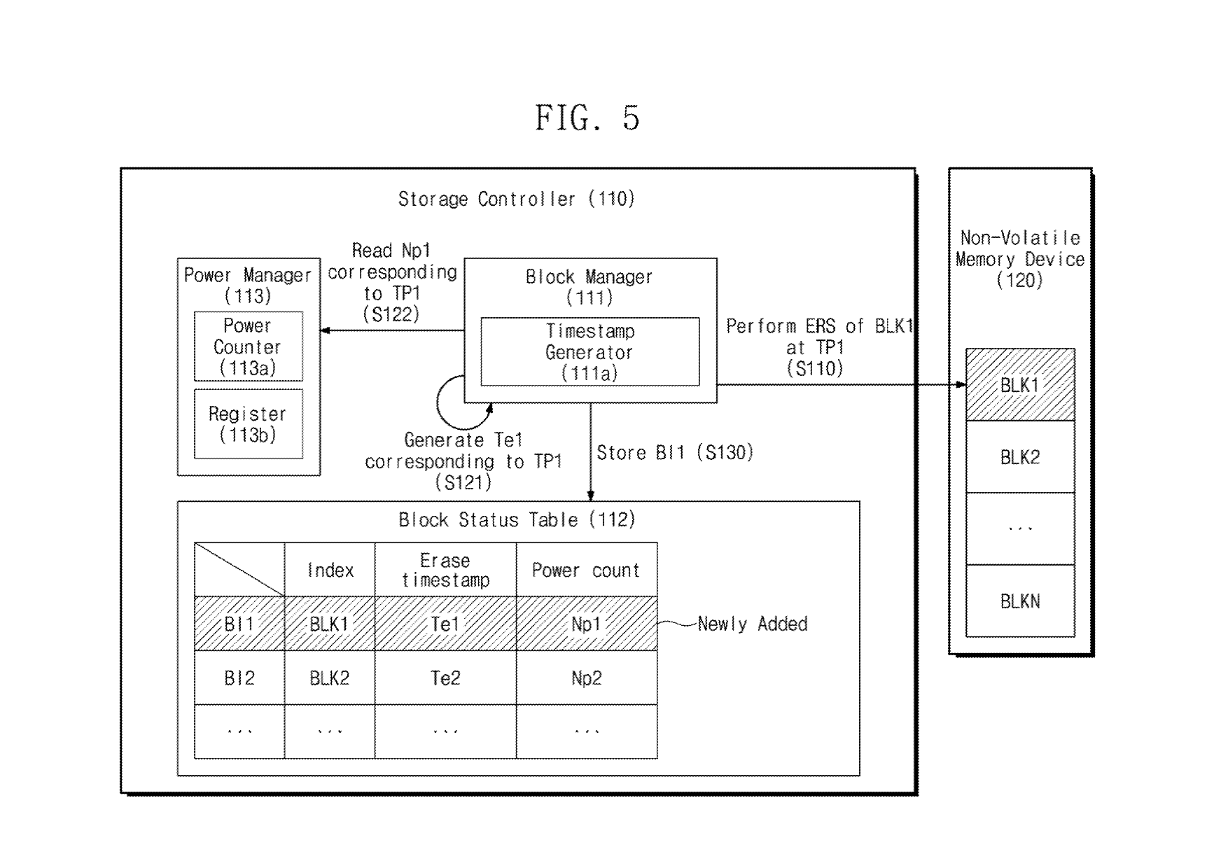

FIG. 5 is a diagram describing an erase operation of a storage device according to embodiments of the present disclosure. Referring to FIG. 5, the storage controller 110 may include the block manager 111, the block status table 112, and the power manager 113. The non-volatile memory device 120 may include first to N-th memory block BLK1 to BLKN. “N” is an arbitrary natural number. The block manager 111, the block status table 112, and the power manager 113 of FIG. 5 may correspond to the block manager 111, the block status table 112, and the power manager 113 of FIG. 1, and thus, additional description will be omitted to avoid redundancy.

The storage controller 110 may control an erase operation ERS of a block of the non-volatile memory device 120. For example, the block manager 111 may provide the non-volatile memory device 120 with a command (e.g., CMD from FIG. 1) indicating the erase operation ERS and an address (e.g., ADD from FIG. 1) indicating a location of the memory block BLK, at which the erase operation ERS will be performed.

The block manager 111 may generate or obtain block status information corresponding to a time point at which the erase operation ERS is performed, based on the done response of the erase operation ERS and may store the block status information in the block status table 112.

The block manager 111 may be configured to generate timestamps, e.g., using a timestamp generator 111a. The timestamp generator 111a may generate a timestamp corresponding to a specific time point. In other words, in an embodiment, , the timestamp generator 111a may generate the timestamp based on time information. The time information may include information associated with a plurality of times, such as year information, month information, and date information.

The timestamp generator 111a may receive the time information from the host device 11. The timestamp generator 111a may include a constant power source. Even though the power of the storage device 100 is not supplied, the timestamp generator 111a may generate the time information based on the constant power source.

The power manager 113 may perform all operations associated with power management of the storage device 100. The power manager 113 may be configured to keep a power count and a register. This may be implemented through a power counter 113a and a register 113b in embodiments.

The power counter 113a may determine whether the power event of the storage device 100 occurs. The power manager 113 may register the power count value of the storage device 100. The power manager 113 may increase the power count value as much as the unit value in response to determining that the power event occurs.

The register 113b may register the power count value of the storage device 100. The power counter 113a may increase the power count value of the register 113b as much as the unit value in response to determining that the power event occurs.

Below, the erase operation ERS of the storage device 100 according to embodiments of the present disclosure and an operation of storing the block status information corresponding to the erase operation ERS will be described.

In operation S110, the storage controller 110 may perform the erase operation ERS of the first memory block BLK1 at a first time point TP1. In other words, in an embodiment, , the block manager 111 may perform the erase operation ERS of the first memory block BLK1 at the first time point TP1. The block manager 111 may provide the non-volatile memory device 120 with a command indicating the erase operation ERS and an address indicating a location of the first memory block BLK1, at which the erase operation ERS will be performed. The non-volatile memory device 120 may perform the erase operation ERS of the first memory block BLK1 based on the command and the address and may return, to the storage controller 110, the done response indicating that the erase operation ERS is performed.

Operation S120 may include operation S121 and operation S122. In operation S120, the storage controller 110 may generate first block status information BI1, based on the done response of the erase operation ERS.

In operation S121, the storage controller 110 may generate a first erase timestamp Te1 corresponding to the first time point TP1. In other words, in an embodiment, , the timestamp generator 111a of the block manager 111 may generate the first erase timestamp Te1 corresponding to the first time point TP1, based on the done response of the erase operation ERS.

In operation S122, the storage controller 110 may read a first erase power count value Np1 corresponding to the first time point TP1. In other words, in an embodiment, , the block manager 111 may read the power count value of the register 113b, based on the done response of the erase operation ERS. The power count value of the register 113b thus read may be referred to as the “first erase power count value Np1”. In other words, the first erase power count value Np1 may correspond to the first time point TP1 at which the erase operation ERS of the first memory block BLK1 is performed.

In operation S130, the storage controller 110 may store the first block status information BI1. The first block status information BI1 may include information about the first memory block BLK1. For example, the first block status information BI1 may include the first erase timestamp Te1 generated in operation S121 and the first erase power count value Np1 obtained in operation S122.

The block manager 111 may provide the first block status information BI1 to the block status table 112. The block status table 112 may store the first block status information BI1 thus provided.

Based on the first block status information BI1, the storage controller 110 may determine whether to execute the defense code for the first memory block BLK1. The operating method of the storage controller 110 based on the first block status information BI1 will be described with reference to FIGS. 7 to 9.

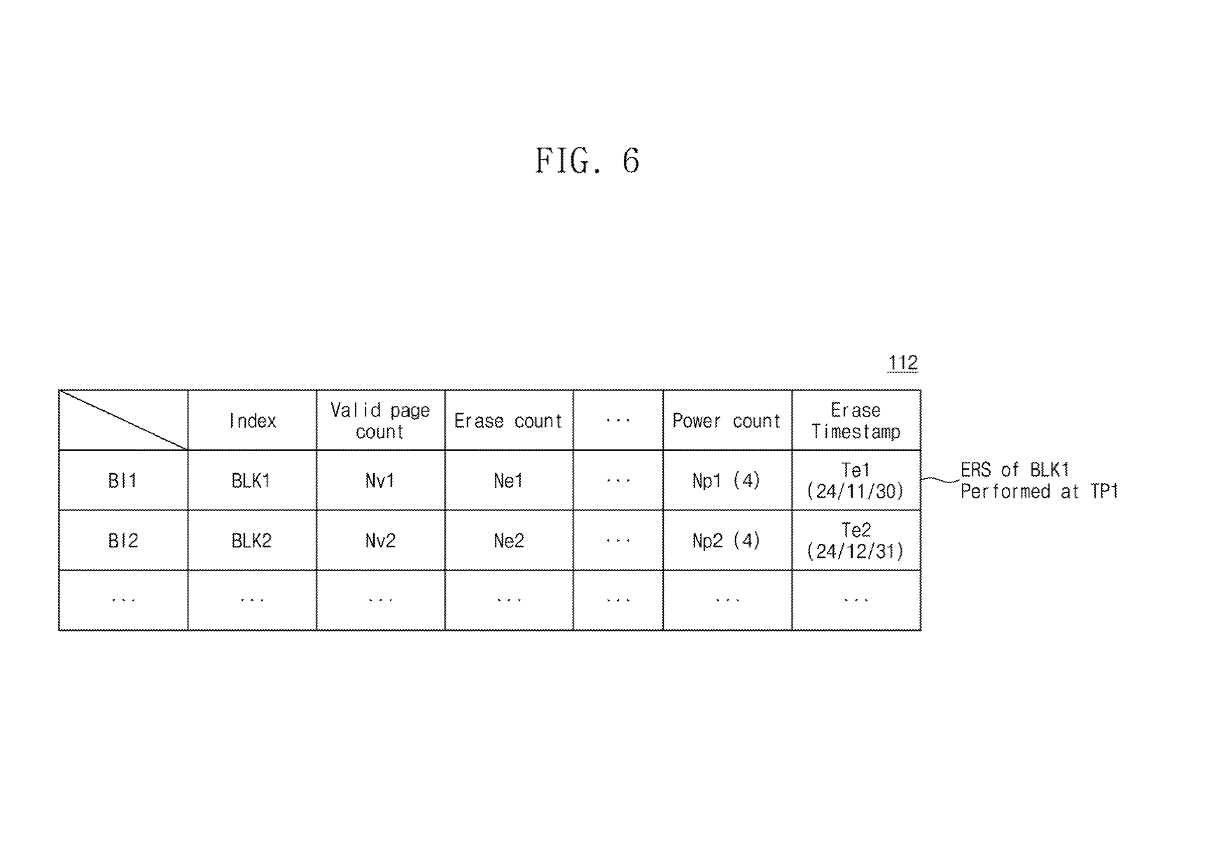

FIG. 6 is a diagram describing a block status table according to embodiments of the present disclosure. Referring to FIG. 6, the block status table 112 may include the first block status information BI1 and second block status information BI2. The first block status information BI1 and the second block status information BI2 of FIG. 6 may correspond to the first block status information BI1 and the second block status information BI2 of FIG. 5, and thus, additional description will be omitted to avoid redundancy.

The first block status information BI1 may include information about the first memory block BLK1. The first time point TP1 may be a time point at which the erase operation ERS of the first memory block BLK1 is performed.

The first block status information BI1 may include a first valid page count value Nv1, a first erase count value Ne1, a first erase power count value Np1, and the first erase timestamp Te1.

The first memory block BLK1 may include a plurality of pages. The first valid page count value Nv1 may indicate the number of valid pages among the plurality of pages.

The first erase count value Ne1 may indicate the number of times that the first memory block BLK1 is erased. The first memory block BLK1 may be degraded depending on the iteration of the program-erase cycle. The first erase count value Ne1 may be used to estimate the degree of degradation of the first memory block BLK1.

The first erase power count value Np1 may correspond to the first erase power count value Np1 of FIG. 5. The first erase power count value Np1 may correspond to the power count value of the storage device at the first time point TP1.

The first erase timestamp Te1 may be correspond to the first erase timestamp Te1 of FIG. 5. The first erase timestamp Te1 may correspond to the first time point TP1. In other words, in an embodiment, , the first erase timestamp Te1 may indicate a date corresponding to the first time point TP1. For example, the first erase timestamp Te1 may indicate November 30, 2024.

The first block status information BI1 of the first memory block BLK1 may correspond to the first time point TP1. A storage controller may determine whether to execute the defense code for the first memory block BLK1, based on the first block status information BI1.

The second block status information BI2 may correspond to the second memory block BLK2. As in the first block status information BI1, the second block status information BI2 may include a second valid page counting Nv2, a second erase count value Ne2, a second erase power count value Np2, and a second erase timestamp Te2.

FIG. 7 is a diagram describing an operation method of a storage device according to embodiments of the present disclosure. Referring to FIG. 7, the storage device 100 may include the storage controller 110 and the non-volatile memory device 120. The storage controller 110 may include the block manager 111, the block status table 112, and the power manager 113. The non-volatile memory device 120 may include the first to N-th memory block BLK1 to BLKN. “N” is an arbitrary natural number.

The block manager 111, the block status table 112, and the power manager 113 of FIG. 7 may correspond to the block manager 111, the block status table 112, and the power manager 113 of FIG. 1 (or any figure described herein), and thus, additional description will be omitted to avoid redundancy.

The block manager 111 may execute the defense code for the non-volatile memory device 120. In other words, in an embodiment, , the block manager 111 may perform an operation for improving the reliability or integrity of data stored in the non-volatile memory device 120, based on the defense code. For example, the block manager 111 may perform the error correction operation, the reclaim operation, the background read operation, the patrol read operation, etc. based on the defense code.

The block manager 111 may be configured to generate timestamps using, for example, the timestamp generator 111a. The timestamp generator 111a may generate a timestamp corresponding to a specific time point. The timestamp generator 111a of FIG. 7 may correspond to the timestamp generator 111a of FIG. 5, and thus, additional description will be omitted to avoid redundancy.

The power manager 113 may perform all operations associated with power management of the storage device 100. The power manager 113 may be configured to store a power counter and maintain a register, for example, the power counter 113a and the register 113b.

The power manager 113 may perform all operations associated with power management of the storage device 100. The power manager 113 may include the power counter 113a and the register 113b. The power counter 113a and the register 113b of FIG. 7 may correspond to the power counter 113a and the register 113b of FIG. 5, and thus, additional description will be omitted to avoid redundancy.

The power counter 113a may determine whether the power event of the storage device 100 occurs. The power manager 113 may register the power count value of the storage device 100. The power manager 113 may increase the power count value as much as the unit value in response to determining that the power event occurs.

Below, an operation in which the storage device 100 according to embodiments of the present disclosure selectively performs the defense code will be described.

In operation S210, the storage controller 110 may read the first block status information BI1. In other words, in an embodiment, , the block manager 111 may read the first block status information BI1 from the block status table 112.

The first block status information BI1 of FIG. 7 may correspond to the first block status information BI1 stored in the block status table 112 through operation S110 to operation S130 of FIG. 5. The first block status information BI1 may include information about the first memory block BLK1. The first memory block BLK1 may be a latent target for executing the defense code.

The first erase timestamp Te1 may correspond to a first time point. The first time point may be a time point at which the erase operation of the first memory block BLK1 is performed.

The first erase power count value Np1 may correspond to the first time point. In other words, in an embodiment, , the first erase power count value Np1 may correspond to the power count value of the storage device 100 at the first time point.

In operation S220, the storage controller 110 may read a current power count value Npx. That is, in an embodiment, the block manager 111 may read the current power count value Npx registered at the register 113b. The current power count value Npx may correspond to a current time point TPx. The current time point TPx may be a time point at which operation S210 is performed.

In operation S230, the storage controller 110 may determine whether the current power count value Npx and the first erase power count value Np1 coincide with each other. In other words, in an embodiment, , the block manager 111 may determine that the current power count value Npx and the first erase power count value Np1 coincide with each other.

That the current power count value Npx and the first erase power count value Np1 do not coincide with each other may indicate that the power event does not occur in the storage device 100 to the current time point from the first time point TP1 at which the erase operation is lastly performed in the first memory block BLK1. Because the power event does not occur, the reliability of data stored in the storage device 100 may be high.

In operation S240, the storage controller 110 may generate a current timestamp Tex in response to determining that the current power count value Npx and the first erase power count value Np1 coincide with each other. In other words, in an embodiment, , the timestamp generator 111a may generate the current timestamp Tex based on time information corresponding to a current time.

In operation S250, the storage controller 110 may determine that an erase time period between the current timestamp Tex and the first erase timestamp Te1 does not exceed a threshold time period Tref. In other words, in an embodiment, , the block manager 111 may calculate the erase time period based on the current timestamp Tex and the first erase timestamp Te1. For example, the erase time period may be a difference between the current timestamp Tex and the first erase timestamp Te1. The block manager 111 may store the threshold time period Tref. The block manager 111 may compare the erase time period and the threshold time period Tref and may determine that the erase time period does not exceed the threshold time period Tref.

That the erase time period does not exceed the threshold time period Tref may indicate that the retention time of data of the first memory block BLK1 is short. The reason is that the data write operation of the storage device 100 presupposes the erase operation of data at a high frequency. When the retention time of the first memory block BLK1 is short, the execution of the defense code for the first memory block BLK1 may be unnecessary. This omission of execution of the defense code improves the performance of the storage controller and the associated host by at least reducing read disturb and reducing wastage of computational resources of the device.

In operation S260, the storage controller 110 may read the second block status information BI2 in response to determining that the erase time period does not exceed the threshold time period Tref. In other words, in an embodiment, , the block manager 111 may read the second block status information BI2, and the second block status information BI2 may include information about the second memory block BLK2.

As in the above description given in operation S210 to operation S250, the storage controller 110 may determine whether to execute the defense code in the second memory block BLK2, based on the second block status information BI2.

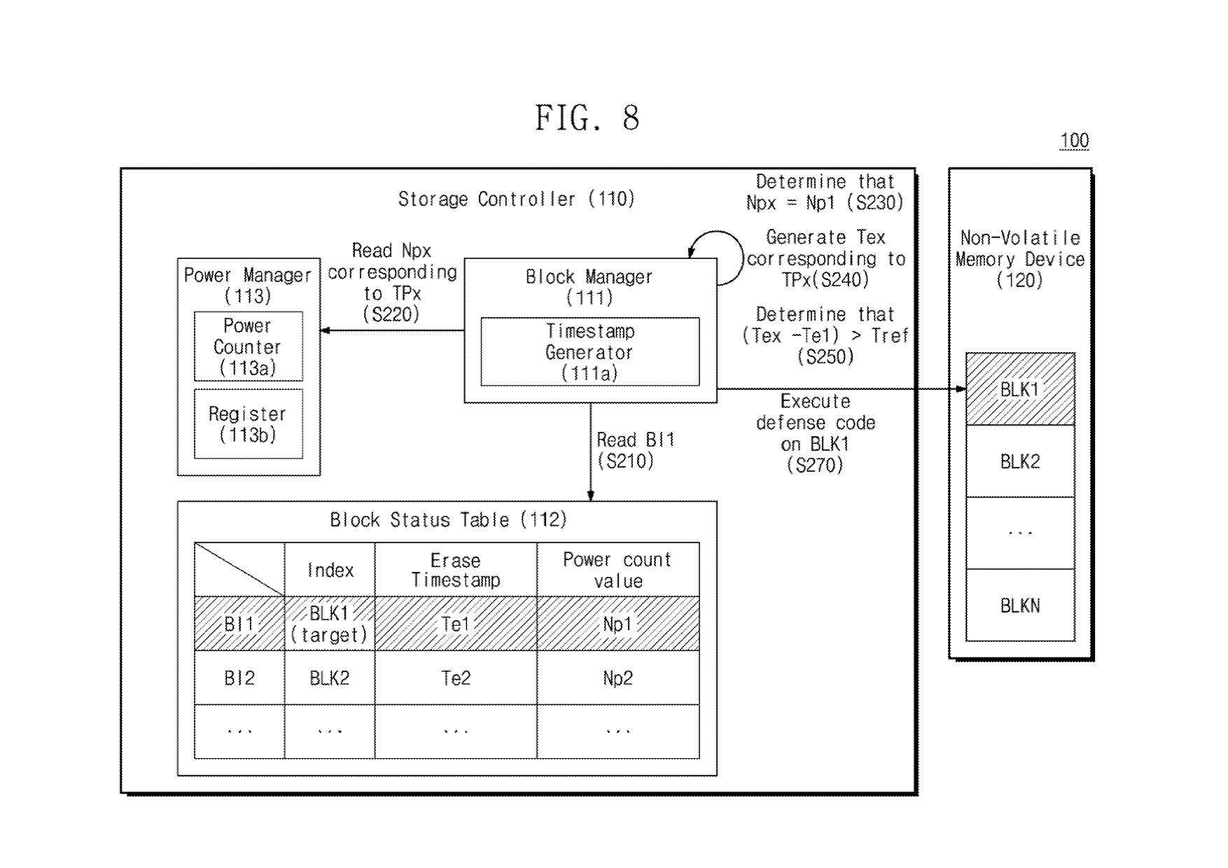

FIG. 8 is a diagram describing an operation method of a storage device according to embodiments of the present disclosure. Referring to FIG. 8, the storage device 100 may include the storage controller 110 and the non-volatile memory device 120. The storage controller 110 may include the block manager 111, the block status table 112, and the power manager 113. The non-volatile memory device 120 may include the first to N-th memory block BLK1 to BLKN. “N” is an arbitrary natural number.

The block manager 111, the block status table 112, and the power manager 113 of FIG. 8 may correspond to the block manager 111, the block status table 112, and the power manager 113 of FIGS. 1 and 7, and thus, additional description will be omitted to avoid redundancy.

The block manager 111 may execute the defense code for the non-volatile memory device 120. The block manager 111 may include the timestamp generator 111a.

The power manager 113 may perform all operations associated with power management of the storage device 100. The power manager 113 may include the power counter 113a and the register 113b.

Below, an operating method of the storage controller 110 which determines that the erase time period exceeds the threshold time period Tref and executes the defense code in response to determining that the erase time period exceeds the threshold time period Tref will be described. Because operation S210 to operation S240 of FIG. 8 are similar to S210 to operation S240 of FIG. 7, additional description will be omitted to may be omitted redundancy.

In operation S210, the storage controller 110 may store the first block status information BI1. The first block status information BI1 of FIG. 8 may correspond to the first block status information BI1 stored in the block status table 112 through operation S110 to operation S130 of FIG. 5.

In operation S220, the storage controller 110 may read the current power count value Npx. In other words, in an embodiment, , the block manager 111 may read the current power count value Npx registered at the register 113b. The current power count value Npx may correspond to the current time point TPx. The current time point TPx may be a time point at which operation S210 is performed.

In operation S230, the storage controller 110 may determine whether the current power count value Npx and the first erase power count value Np1 coincide with each other. In other words, in an embodiment, , the block manager 111 may determine that the current power count value Npx and the first erase power count value Np1 coincide with each other.

In operation S240, the storage controller 110 may generate the current timestamp Tex in response to that the current power count value Npx and the first erase power count value Np1 coincide with each other.

In operation S250, the storage controller 110 may determine that the erase time period between the current timestamp Tex and the first erase timestamp Te1 exceeds the threshold time period Tref. In other words, in an embodiment, , the block manager 111 may calculate the erase time period based on the current timestamp Tex and the first erase timestamp Te1. For example, the erase time period may be a difference between the current timestamp Tex and the first erase timestamp Te1. The block manager 111 may store the threshold time period Tref. The block manager 111 may compare the erase time period and the threshold time period Tref and may determine that the erase time period does exceeds the threshold time period Tref.

That the erase time period exceeds the threshold time period Tref may indicate that the retention time of data of the first memory block BLK1 is long. As the retention time of the first memory block BLK1 increases, the reliability of data of the first memory block BLK1 may decrease; in this case, it may be necessary to execute the defense code.

In operation S270, the storage controller 110 may execute the defense code in the first memory block BLK1 in response to determining, in operation S250, that the erase time period exceeds the threshold time period Tref. In other words, in an embodiment, , the block manager 111 may execute the defense code in the first memory block BLK1. The block manager 120 may perform the read operation on the first memory block BLK1, based on the defense code.

In embodiments, the block manager 111 may perform the error correction operation, the reclaim operation, the background read operation, the patrol read operation, etc. based on the defense code.

In embodiments, the block manager 111 may update the first block status information BI1. In other words, in an embodiment, , the non-volatile memory device 120 may provide the done response in operation S270 to the block manager 111. The done response may indicate that the defense code for the first memory block BLK1 is completely executed. When the done response is received, the block manager 111 may update the first block status information BI1. For example, the block manager 111 may replace the first erase timestamp Te1 of the first block status information BI1 with the current timestamp Tex. The block manager 111 may replace the first erase power count value Np1 of the first block status information BI1 with the current power count value Npx.

In embodiments, the storage controller 110 may perform operation S220 and operation S240 in parallel. In other words, in an embodiment, , the storage controller 110 may perform the operations of reading the current power count value Npx and generating the current timestamp Tex in parallel.

For better understanding of the present disclosure, the description is given as operation S240 is performed in response to determining, in operation S230, that the current power count value Npx and the first erase power count value Np1 coincide with each other, but the scope of the present disclosure is not limited thereto. For example, operation S240 and operation S250 may be performed independently of operation S220 and operation S230.

In other words, in an embodiment, , in the case of determining that the erase time period exceeds the threshold time period Tref, the storage controller 110 may execute the defense code for the first memory block BLK1 regardless of whether the current timestamp Tex and the first erase timestamp Te1 coincide with each other.

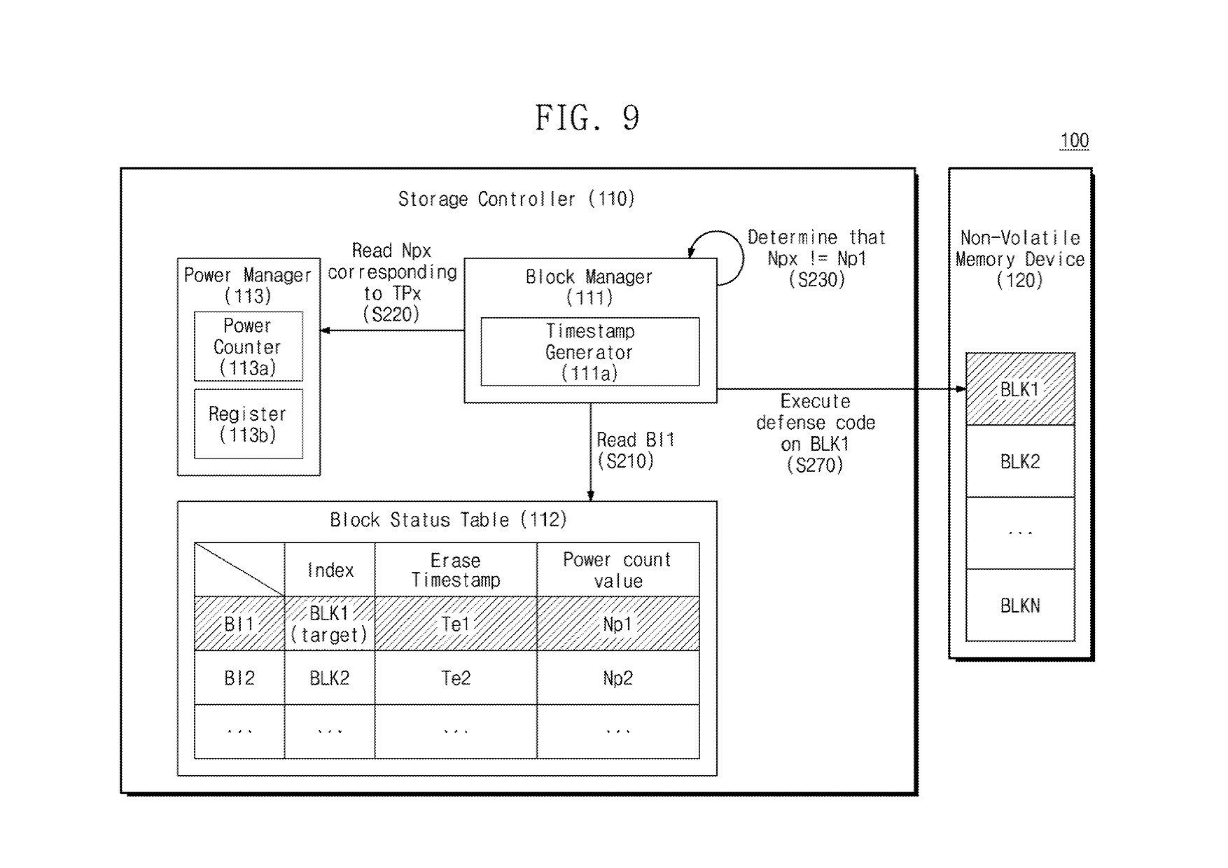

FIG. 9 is a diagram describing an operating method of a storage device according to embodiments of the present disclosure. The storage device 100 may include the storage controller 110 and the non-volatile memory device 120. Referring to FIG. 9, the storage controller 110 may include the block manager 111, the block status table 112, the power manager 113. The non-volatile memory device 120 may include the first to N-th memory block BLK1 to BLKN. “N” is an arbitrary natural number.

The block manager 111, the block status table 112, and the power manager 113 of FIG. 9 may correspond to the block manager 111, the block status table 112, and the power manager 113 of FIGS. 1 and 7, and thus, additional description will be omitted to avoid redundancy.

The block manager 111 may execute the defense code for the non-volatile memory device 120. The block manager 111 may include the timestamp generator 111a.

The power manager 113 may perform all operations associated with power management of the storage device 100. The power manager 113 may include the power counter 113a and the register 113b.

Below, an operating method of the storage controller 110 which determines whether to execute the defense code based on the power count value will be described. Because operation S210 and operation S220 of FIG. 9 are similar and S210 to operation S220 of FIG. 7, additional description will be omitted to may be omitted redundancy.

In operation S210, the storage controller 110 may read the first block status information BI1. The first block status information BI1 of FIG. 9 may correspond to the first block status information BI1 stored in the block status table 112 through operation S110 to operation S130 of FIG. 5.

In operation S220, the storage controller 110 may read the current power count value Npx. In other words, in an embodiment, , the block manager 111 may read the current power count value Npx registered at the register 113b. The current power count value Npx may correspond to the current time point TPx. The current time point TPx may be a time point at which operation S210 is performed.

In operation S230, the storage controller 110 may determine that the current power count value Npx and the first erase power count value Np1 do not coincide with each other. In other words, in an embodiment, , the block manager 111 may determine that the current power count value Npx and the first erase power count value Np1 do not coincide with each other.

That the current power count value Npx and the first erase power count value Np1 do not coincide with each other may indicate that the power event occurs between a time point at which the erase operation of the first memory block BLK1 is performed and a current time point. The occurrence of the power event in the storage device 100 may cause the reduction of reliability of data stored in the first memory block BLK1. Accordingly, the execution of the defense code for the first memory block BLK1 may be required.

In operation S270, the storage controller 110 may execute the defense code in the first memory block BLK1 in response to determining, in operation S230, that the current power count value Npx and the first erase power count value Np1 do not coincide with each other. In other words, in an embodiment, , the block manager 111 may execute the defense code in the first memory block BLK1. Because operation S270 of FIG. 9 corresponds to operation S270 of FIG. 8, additional description will be omitted to avoid redundancy.

As described above, the storage controller 110 according to embodiments of the present disclosure may determine whether to execute the defense code, based on the erase time period and the power count value. The execution of the defense code may accompany the read operation. The frequent read operation may cause a negative effect such as read disturb. When the erase time period is shorter than the threshold time period Tref, the reliability of data may be high, and thus, it may be unnecessary to execute the defense code for preventing or recovering an error. As the unnecessary execution of the defense code is omitted, a computational resource for executing the defense code may be saved, and the read disturb according to the read operation of the defense code may be suppressed. That is, the computational efficiency of the storage controller and the associated host is improved.

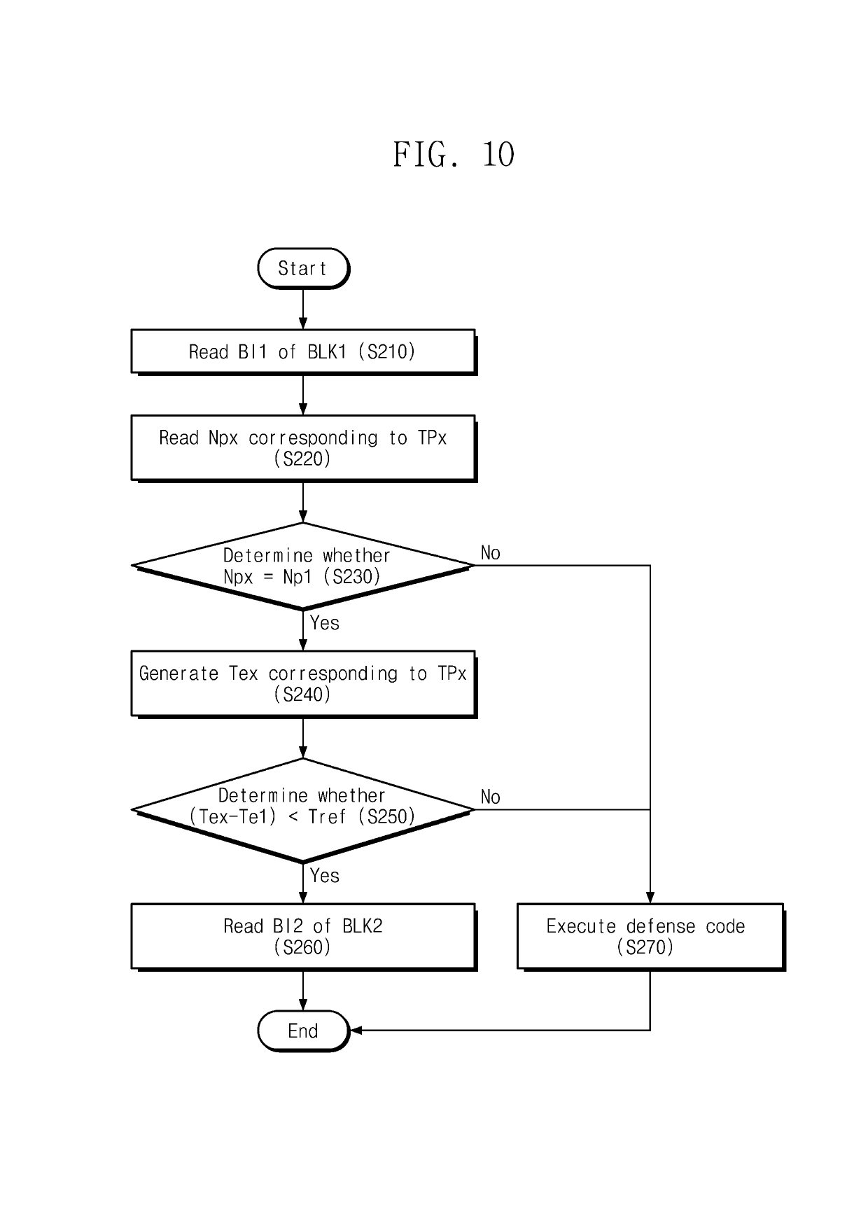

FIG. 10 is a flowchart describing an operating method of a storage controller, according to embodiments of present disclosure. An operating method of a storage controller will be described with reference to FIG. 10. Operation S210 to operation S270 of FIG. 10 may correspond to operation S210 to operation S270 described with reference to FIGS. 7 to 9.

In operation S210, the storage controller may read the first block status information BI1. The first block status information BI1 may include information about the first memory block BLK1. The first block status information BI1 may include the first erase timestamp Te1 and the first erase power count value Np1.

In operation S220, the storage controller may read the current power count value Npx from a power manager of the storage controller. The current power count value Npx may correspond to the current time point TPx.

In operation S230, the storage controller may determine whether the current power count value Npx and the first erase power count value Np1 coincide with each other. The storage controller 110 may execute the defense code for the first memory block BLK1 in response to determining that the current power count value Npx and the first erase power count value Np1 do not coincide with each other.

In operation S240, the storage controller may generate the current timestamp Tex in response to determining, in operation S230, that the current power count value Npx and the first erase power count value Np1 coincide with each other. The current timestamp Tex may correspond to the current time point TPx.

In operation S250, the storage controller may determine whether the erase time period between the current timestamp Tex and the first erase timestamp Te1 exceeds the threshold time period Tref. The storage controller may execute the defense code for the first memory block BLK1, in operation S270, in response to determining that the erase time period exceeds the threshold time period Tref.

In operation S260, the storage controller may read the second block status information BI2 of the second memory block BLK2 in response to determining, in operation S250, that the erase time period does not exceed the threshold time period Tref. In other words, the storage controller may omit the execution of the defense code for the first memory block BLK1.

In operation S270, the storage controller may execute the defense code for the first memory block BLK1.

As described above, a storage controller according to embodiments of the present disclosure may determine whether to execute the defense code based on the erase time period and the power count value. The execution of the defense code may cause a negative effect such as read disturb. As the unnecessary execution of the defense code is omitted, a computational resource for executing the defense code may be saved, and the read disturb according to the read operation of the defense code may be suppressed.

According to an embodiment of the present disclosure, a storage controller executing a defense code, an operating method thereof, and an electronic device including the same are provided.

According to embodiments of the present disclosure, a read operation based on a defense code and a negative effect according to the read operation may decrease by omitting the execution of the defense code for data with a short retention time.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method operating a storage controller that is configured to communicate with a non-volatile memory device, the method comprising:
reading first block status information of a first memory block of the non-volatile memory device, wherein the first block status information comprises a first erase timestamp and a first power count value of the first memory block;
reading a current power count value associated with the storage controller;
generating a current timestamp associated with the storage controller based on the first power count value coinciding with the current power count value; and
performing a read operation of the first memory block in accordance with a defense code based on an erase time period between the current timestamp and the first erase timestamp exceeding a threshold time period.

2. The method of claim 1, further comprising:
performing the read operation of the first memory block in accordance with the defense code based on the current power count value not coinciding with the first power count value.

3. The method of claim 1, further comprising:
reading a second block status information of a second memory block of the non-volatile memory device based on determining that the erase time period does not exceed the threshold time period.

4. The method of claim 1, further prior to reading the first block status information of the first memory block, the method further comprises:
performing an erase operation of the first memory block;
reading the first power count value associated with the storage controller;
generating the first erase timestamp; and
storing the first block status information comprising the first erase timestamp and the first power count value in a block status table associated with the storage controller.

5. The method of claim 1, further comprising:
subsequent to a power-off, detecting a power resupply event; and
based on detecting the power resupply event, updating the current power count value in a register associated with a power counter to be increased at most a unit magnitude.

6. The method of claim 1, wherein the storage controller comprises a timestamp generator, and
wherein the timestamp generator is configured to generate the current timestamp corresponding to a date of a current time.

7. The method of claim 6, wherein the timestamp generator is configured to receive power from a constant power source, and
wherein the timestamp generator is further configured to generate time information based on the constant power source and to generate the current timestamp based on the time information.

8. The method of claim 1, wherein the read operation of the first memory block is a first read operation, and wherein the first erase timestamp has a length of 16-bits, and the first power count value has a length of 16-bits.

9. The method of claim 1, wherein the performing of the read operation of the first memory block in accordance with the defense code comprises:
selecting a representative page of the first memory block; and
performing a second read operation on the representative page.

10. The method of claim 1, wherein the first block status information further comprises a valid page count value of the first memory block and an erase count value of the first memory block.

11. The method of claim 1, wherein an erase operation of the first memory block is performed at a first time point,
wherein the first erase timestamp corresponds to a date of the first time point, and
wherein the first power count value corresponds to a power count value at the first time point.

12. A storage controller configured to communicate with a non-volatile memory device, the storage controller comprising:
a block manager configured to generate timestamps;
a block status table configured to store first block status information of a first memory block of the non-volatile memory device; and
a power manager configured to register a current power count value,
wherein the block manager is configured to:
read the first block status information;
read the current power count value;
generate a current timestamp based on the current power count value coinciding with a first power count value of the first block status information; and
perform a read operation of the first memory block in accordance with a defense code based on an erase time period between the current timestamp and a first erase timestamp exceeding a threshold time period.

13. The storage controller of claim 12, wherein the block manager is further configured to:
perform the read operation of the first memory block in accordance with the defense code based on the current power count value not coinciding with the first power count value.

14. The storage controller of claim 12, wherein the block manager is further configured to:
read second block status information of a second memory block of the non-volatile memory device based on the erase time period not exceeding the threshold time period.

15. The storage controller of claim 12, wherein the block manager is further configured to:
perform an erase operation of the first memory block;
read the first power count value;
generate the first erase timestamp; and
store the first block status information comprising the first erase timestamp and the first power count value in the block status table.

16. The storage controller of claim 12, wherein the power manager comprises a power counter and a register, and
wherein the power counter is configured to:
detect a power resupply event of the storage controller; and
increase the current power count value in the register by at most a unit magnitude based on detecting the power resupply event.

17. The storage controller of claim 12, wherein the block manager further comprises a constant power source, and
wherein the block manager is further configured to:
generate time information based on the constant power source; and generate the current timestamp based on the time information.

18. A storage device comprising:
a non-volatile memory device comprising a first memory block; and
a storage controller configured to communicate with the non-volatile memory device,
wherein the storage controller comprises:
a block manager configured to generate timestamps;
a block status table configured to store first block status information of the first memory block; and
a power manager configured to register a current power count value,
wherein the block manager is further configured to:
read the first block status information;
read the current power count value;
generate a current timestamp based on the current power count value coinciding with a first power count value of the first block status information; and
perform a read operation of the first memory block in accordance with a defense code based on an erase time period between the current timestamp and a first erase timestamp exceeding a threshold time period.

19. The storage device of claim 18, wherein the block manager is further configured to perform the read operation of the first memory block in accordance with the defense code based on the current power count value not coinciding with the first power count value.

20. The storage device of claim 18, wherein the erase time period is a first erase time period,
wherein the non-volatile memory device further includes a second memory block,
wherein the block status table is configured to store second block status information of the second memory block, and
wherein the block manager is further configured to read the second block status information from the block status table based on the erase time period not exceeding the threshold time period.
